(19) United States
(12) Patent Application Publication
(10) Pub. No.: US 2016/0146404 A1
(43) Pub. Date: May 26, 2016

(54) OPTICAL SEMICONDUCTOR LIGHTING APPARATUS

(71) Applicant: POSCO LED COMPANY LTD., Seongnam-si (KR)

(72) Inventors: Jin Jong KIM, Seongnam-si (KR); Dong Hee Kim, Seongnam-si (KR); Kyung Rye Kim, Seongnam-si (KR); Dae Won Kim, Seongnam-si (KR); Jung Hwa Kim, Seongnam-si (KR)

(21) Appl. No.: 14/552,961

(22) Filed: Nov. 25, 2014

(51) Int. Cl. F21K 99/00; F21V 29/70

(52) U.S. Cl. CPC F21K 9/135; F21K 9/50; F21V 29/70; F21Y 2101/02

(57) ABSTRACT

An optical semiconductor lighting apparatus includes: a heat sink; a light emitting module contacting the heat sink and comprising a substrate on which one or more optical semiconductor devices are mounted; and an optical member coupled to the heat sink and covering the light emitting module, wherein the optical member includes a substrate positioning slot having a shape corresponding to a periphery of the substrate; and a step having a shape corresponding to a cutaway slot at the periphery of the substrate.

### BACKGROUND

1. Field

Exemplary embodiments relate to an optical semiconductor lighting apparatus. More particularly, exemplary embodiments relate to an optical semiconductor lighting apparatus which can protect optical semiconductor devices and circuit components from withstand voltage, achieve efficient and simple assembly and fastening, and realize desired light distribution.

2. Discussion of the Background

Optical semiconductor devices, such as light emitting diodes (LEDs) or laser diodes (LDs), have attracted increasing attention due to advantages such as low power consumption, long lifespan, high durability, and excellent brightness, as compared with incandescent lamps or fluorescent lamps.

Unlike fluorescent lamps or mercury lamps manufactured by injecting argon gas and toxic mercury into a glass tube, optical semiconductor devices do not use substances toxic to the environment, thereby providing eco-friendly products.

Particularly, lighting apparatuses using optical semiconductor devices as a light source are recently employed for outdoor landscape lighting or security, and thus easy assembly and installation thereof is required.

In addition, such lighting apparatuses using optical semiconductor devices as a light source are required to allow replacement or repair upon failure and malfunction.

The above information disclosed in this Background section is only for enhancement of understanding of the background of the inventive concept, and, therefore, it may contain information that does not form the prior art that is already known in this country to a person of ordinary skill in the art.

### SUMMARY

The present invention has been conceived to solve such problems in the related art and is aimed at providing an optical semiconductor lighting apparatus which can protect optical semiconductor devices and circuit components from withstand voltage, achieve efficient and simple assembly and fastening, and realize desired light distribution.

Additional aspects will be set forth in the detailed description which follows, and, in part, will be apparent from the disclosure, or may be learned by practice of the inventive concept.

In accordance with one aspect of the present invention, an optical semiconductor lighting apparatus includes: a heat sink; a light emitting module contacting the heat sink and including a substrate on which one or more optical semiconductor devices are mounted; and an optical member coupled to the heat sink and covering the light emitting module, wherein the optical member includes a substrate positioning slot having a shape corresponding to a periphery of the substrate; and a step having a shape corresponding to a cutaway slot at the periphery of the substrate.

The substrate positioning slot may secure the periphery of the substrate to the heat sink.

The optical member may further include a flat portion of a flat plate shape having a predetermined thickness and facing the heat sink; and a curved portion extending from a periphery of the flat portion to the heat sink and having a gradually increasing cross-section toward the heat sink.

The curved portion may have the same thickness as the flat portion or a different thickness from the flat portion.

The optical member may further include a cover having a space for receiving the substrate therein; and a flange extending from a periphery of the cover and secured to the heat sink, wherein the substrate positioning slot may be formed at an inner periphery of the flange.

The optical member may further include a flat portion of a flat plate shape having a predetermined thickness and facing the heat sink; and a curved portion extending from a periphery of the flat portion to the flange and having a gradually increasing cross-section toward the flange, wherein the substrate positioning slot may be formed at a portion where the curved portion and the flange meet.

The curved portion may have the same thickness as the flat portion or a different thickness from the flat portion.

The optical semiconductor lighting apparatus may further include a plurality of side protrusions formed on an inner surface of the optical member, wherein the step may be formed stepwise at an end of the side protrusions.

The cutaway slot may be separated a predetermined distance from the optical semiconductor device.

The side protrusions may be formed at constant intervals on the inner surface of the optical member.

The side protrusions may be radially arranged with respect to a center of the optical member.

Each of the side protrusions may include a pressing face forming a periphery of the step and serving as an end of the side protrusions, and the pressing face may contact the substrate.

The heat sink may be formed of a metallic material, and the optical member, the substrate positioning slot, and the step may be formed of a resin.

The optical member may further include a flange extending from a periphery of the optical member and contacting the heat sink, wherein the flange may be secured to the heat sink by a fastener made of a metallic material or resin.

The optical semiconductor lighting apparatus may further include a housing formed at a lower end thereof with an Edison base, wherein the heat sink may be arranged to face an outer surface of the housing.

The optical semiconductor lighting apparatus may further include: a through-hole formed in the heat sink such that a cable of the substrate passes therethrough; a housing formed at a lower end thereof with an Edison base; and a plurality of wire passages arranged at constant intervals on an outer surface of the housing such that the cable of the substrate having passed through the through-hole passes therethrough.

The optical semiconductor lighting apparatus may further include a housing formed at a lower end thereof with an Edison base, wherein a plurality of heat sinks may be arranged at constant intervals to face an outer surface of the housing.

The optical semiconductor devices may be radially arranged with respect to a center of the substrate.

A plurality of optical semiconductor devices may be radially arranged with respect to a center of the substrate and separated a predetermined distance from the periphery of the substrate and an inner end of the cutaway slot.

The optical semiconductor lighting apparatus according to the embodiments of the present invention has the following advantages.

A substrate is indirectly secured to a metallic heat sink through a substrate positioning slot and steps formed on an optical member and having a shape corresponding to cutaway slots of the substrate, instead of being directly secured thereto, thereby protecting optical semiconductor devices and circuit components from withstand voltage.

In the related art, the substrate is secured to the heat sink by a separate fastener and then the optical member is secured to the heat sink by another fastener, whereas, in the embodiments of the invention, when the optical member is secured to the heat sink, the substrate can also be secured to the heat sink by the optical member, thereby achieving efficient and simple assembly and fastening.

In addition, based on structural features of an optical cover including a flat portion and a curved portion, the curved portion can have a uniform thickness or a gradually decreasing or increasing thickness, thereby realizing various desired light distribution.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a partially exploded perspective view of an optical semiconductor lighting apparatus according to one embodiment of the present invention.

FIG. 2 is an exploded perspective view showing coupling relations between a substrate, a heat sink, and an optical member, which are major components of the optical semiconductor lighting apparatus according to the embodiment of the present invention.

FIGS. 3(a) and 3(b) are sectional views of optical members, which are major components of optical semiconductor lighting apparatuses according to various embodiments of the present invention.

FIG. 4 is a plan view showing arrangement of a securing unit and a plurality of optical semiconductor devices arrayed in a light emitting module including a substrate, which is a major component of an optical semiconductor lighting apparatus according to one embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

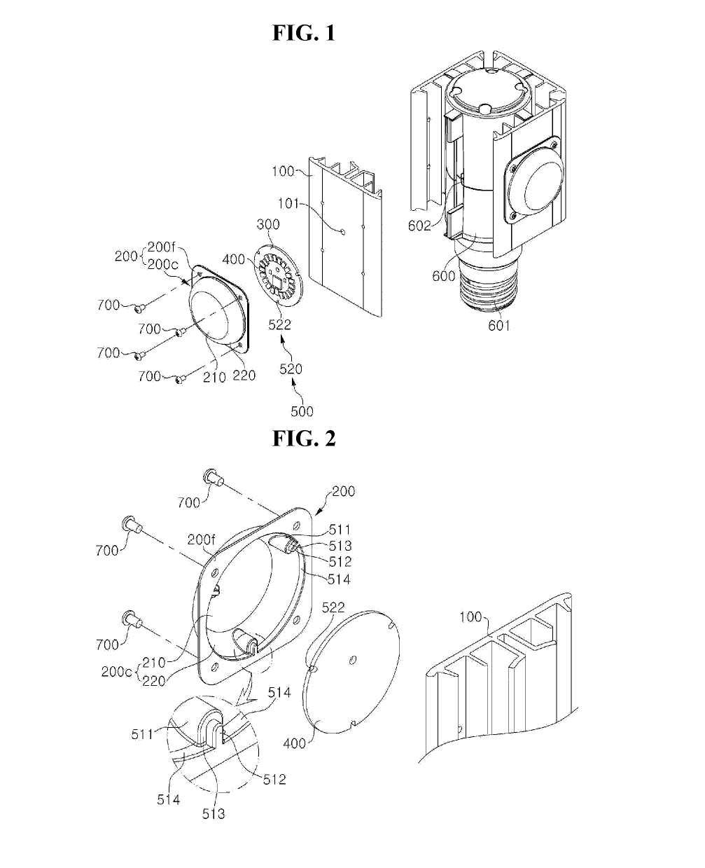

FIG. 1 is a partially exploded perspective view of an optical semiconductor lighting apparatus according to one embodiment of the present invention, and FIG. 2 is an exploded perspective view showing coupling relations between a substrate, a heat sink, and an optical member, which are major components of the optical semiconductor lighting apparatus according to the embodiment of the present invention.

Referring to FIGS. 1 and 2, an optical semiconductor lighting apparatus according to one embodiment of the invention includes heat sinks 100, optical members 200, and light emitting modules including a substrate 300.

Each of the heat sink 100 provides a region to which the optical member 200 and the substrate 300 are attached. The heat sink 100 is formed of a metallic material with high thermal conductivity, such as aluminum or aluminum alloys, to cool the substrate 300 through efficient dissipation of heat from the substrate 300 into the periphery thereof.

Each of the light emitting modules contacts the heat sink 100 and includes the substrate 300 on which one or more optical semiconductor devices 400 are mounted.

The optical member 200 is coupled to the heat sink 100 and realizes various desired light distribution by changing a path of light emitted from the optical semiconductor devices 400.

The optical member 200 is provided with a substrate positioning slot 514 having a shape corresponding to a periphery of the substrate 300, and steps 512 having a shape corresponding to cutaway slots 522 at the periphery of the substrate 300.

The substrate 300 is indirectly secured to the metallic heat sink 100 through the substrate positioning slot 514 and the steps 512 having the shape corresponding to the cutaway slots 522 of the substrate 300 instead of being directly secured thereto, thereby protecting the optical semiconductor devices and circuit components from withstand voltage.

It should be understood that the following various embodiments as well as the above embodiment may be applied to the present invention.

The heat sink 100 is formed of a metallic material, and the optical member 200, the substrate positioning slot 514 and the steps 512 are formed of a resin, thereby protecting various circuit components mounted on the substrate 300 from withstand voltage.

The optical member 200 further includes a flange 200f extending from a periphery thereof and contacting the heat sink 100. The flange 200f is secured to the heat sink 100 by fasteners 700 made of a metallic material or a resin.

Any elements capable of securing the optical member 200 to the heat sink 100, such as metallic bolts or rivets, as shown in FIGS. 1 and 2, or resin adhesive layers, may be used as the fasteners 700.

In other words, the light emitting module including the substrate 300 is secured through the steps 512 and the substrate positioning slot 514 without contacting the metallic bolts or rivets, whereby various circuit components can be protected from withstand voltage.

As shown in FIGS. 1 to 3, the optical member 200 includes a flat portion 210 of a flat plate shape having a predetermined thickness and facing the heat sink 100 and a curved portion 220 extending from a periphery of the flat portion 210 to the heat sink 100 and having a gradually increasing cross-section toward the heat sink 100, and side protrusions 511 are formed on an inner surface of the curved portion 220.

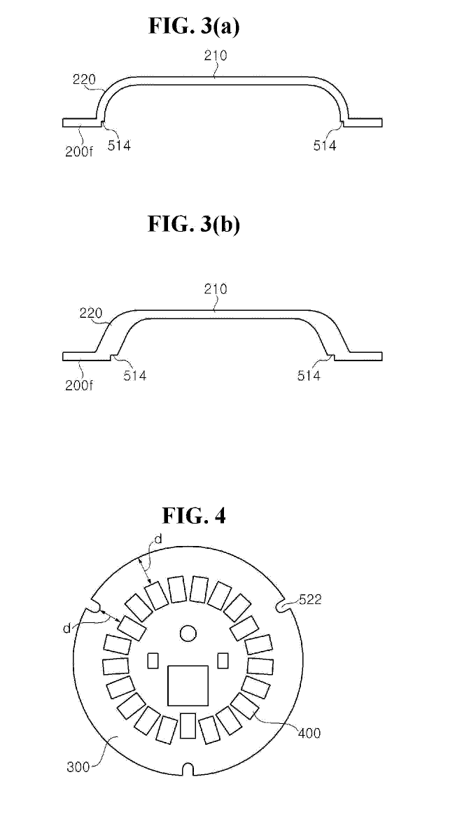

The curved portion 220 may have the same thickness as the flat portion 210, as shown in FIG. 3(a), or a different thickness from the flat portion 210, as shown in FIG. 3(b), thereby obtaining the optical member 200 capable of forming different light distribution.

The optical member 200 includes a cover 200c and the flange 200f, in which the cover 200c includes the flat portion 210 of a flat plate shape having a predetermined thickness and facing the heat sink 100 and provides a space for receiving the substrate 300 therein, and the flange 200f extends from a periphery of the cover 200c and is secured to the heat sink 100.

That is, the cover 200c includes the flat portion 210 and the curved portion 220.

Referring back to FIGS. 1 and 2, the optical semiconductor lighting apparatus according to the embodiment of the invention may further include the side protrusions 511 formed on the inner surface of the optical member 200.

The side protrusions 511 are formed at constant intervals on the inner surface of the optical member 200 and radially arranged with respect to the center of the optical member 200 to accurately and uniformly contact and secure the substrate 300.

Each of the side protrusions 511 includes a pressing face 513 forming a periphery of the corresponding step 512 and serving as an end of the side protrusion 511, and the pressing face 513 contacts the substrate 300.

When the steps 512 formed at the ends of the side protrusions 511 are received in the cutaway slots 522 and the end surfaces of the side protrusions 511, namely, the pressing faces 513 press the substrate 300, the substrate 300 is secured.

Referring again to FIG. 1, the optical semiconductor lighting apparatus according to the invention may further include a housing 600 formed at a lower end thereof with an Edison base 601, and the heat sink 100 is disposed to face an outer surface of the housing 600.

The optical semiconductor lighting apparatus according to the invention may further include a through-hole 101 formed in the heat sink 100 such that a cable (not shown) of the substrate 300 passes therethrough and a plurality of wire passages 602 separated a constant distance from each other on the outer surface of the housing 600 such that the cable of the substrate 300 having passed through the through-hole 101 passes therethrough.

The optical semiconductor devices 400 on the substrate 300 are electrically connected to an external power source by connecting the cable of the substrate 300, passing through the through-hole 101, the corresponding wire passage 602, and the Edison base 601, to the external power source through socket coupling.

According to the present invention, the optical semiconductor lighting apparatus includes the housing 600 formed at the lower end thereof with the Edison base 601 and a plurality of heat sinks 100 is arranged at constant intervals to face the outer surface of the housing 600, whereby the optical semiconductor lighting apparatus can emit light in all directions and can be used as a landscape lighting device.

In addition, as shown in FIG. 4, the optical semiconductor devices 400 are radially arranged with respect to the center of the substrate 300 and separated a predetermined distance (d) from an edge of the substrate 300 and inner ends of the cutaway slots 511, thereby minimizing a dark space while providing uniform and wide light distribution.

As described above, the optical semiconductor lighting apparatus according to the invention can protect the optical semiconductor devices and circuit components from withstand voltage, achieve efficient and simple assembly and fastening, and realize desired light distribution.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An optical semiconductor lighting apparatus comprising:
a heat sink;
a light emitting module contacting the heat sink and comprising a substrate on which one or more optical semiconductor devices are mounted; and
an optical member coupled to the heat sink and covering the light emitting module, the optical member comprising:
a substrate positioning slot having a shape corresponding to a periphery of the substrate; and
a step having a shape corresponding to a cutaway slot at the periphery of the substrate.

2. The optical semiconductor lighting apparatus according to claim 1, wherein the substrate positioning slot secures the periphery of the substrate to the heat sink.

3. The optical semiconductor lighting apparatus according to claim 1, wherein the optical member further comprises:
a flat portion of a flat plate shape having a predetermined thickness and facing the heat sink; and
a curved portion extending from a periphery of the flat portion to the heat sink and having a gradually increasing cross-section toward the heat sink.

4. The optical semiconductor lighting apparatus according to claim 3, wherein the curved portion has the same thickness as the flat portion or a different thickness from the flat portion.

5. The optical semiconductor lighting apparatus according to claim 1, wherein the optical member further comprises:
a cover having a space for receiving the substrate therein; and
a flange extending from a periphery of the cover and secured to the heat sink,
the substrate positioning slot being formed at an inner periphery of the flange.

6. The optical semiconductor lighting apparatus according to claim 5, wherein the optical member further comprises:
a flat portion of a flat plate shape having a predetermined thickness and facing the heat sink; and
a curved portion extending from a periphery of the flat portion to the flange and having a gradually increasing cross-section toward the flange,
the substrate positioning slot being formed at a portion where the curved portion and the flange meet.

7. The optical semiconductor lighting apparatus according to claim 6, wherein the curved portion has the same thickness as the flat portion or a different thickness from the flat portion.

8. The optical semiconductor lighting apparatus according to claim 1, further comprising:
a plurality of side protrusions formed on an inner surface of the optical member,
wherein the step is formed stepwise at an end of the side protrusions.

9. The optical semiconductor lighting apparatus according to claim 1, wherein the cutaway slot is separated a predetermined distance from the optical semiconductor device.

10. The optical semiconductor lighting apparatus according to claim 8, wherein the side protrusions are formed at constant intervals on the inner surface of the optical member.

11. The optical semiconductor lighting apparatus according to claim 8, wherein the side protrusions are radially arranged with respect to a center of the optical member.

12. The optical semiconductor lighting apparatus according to claim 8, wherein each of the side protrusions comprises a pressing face forming a periphery of the step and serving as an end of the side protrusions, and the pressing face contacts the substrate.

13. The optical semiconductor lighting apparatus according to claim 1, wherein the heat sink is formed of a metallic material, and the optical member, the substrate positioning slot, and the step are formed of a resin.

14. The optical semiconductor lighting apparatus according to claim 13, wherein the optical member further comprises:
a flange extending from a periphery of the optical member and contacting the heat sink, the flange being secured to the heat sink by a fastener made of a metallic material or resin.

15. The optical semiconductor lighting apparatus according to claim 1, further comprising:
a housing formed at a lower end thereof with an Edison base,
wherein the heat sink is arranged to face an outer surface of the housing.

16. The optical semiconductor lighting apparatus according to claim 1, further comprising:
a through-hole formed in the heat sink such that a cable passes therethrough;
a housing formed at a lower end thereof with an Edison base; and
a plurality of wire passages arranged at constant intervals on an outer surface of the housing such that the cable passed through the through-hole passes therethrough.

17. The optical semiconductor lighting apparatus according to claim 1, further comprising:
a housing formed at a lower end thereof with an Edison base,
wherein a plurality of heat sinks is arranged at constant intervals to face an outer surface of the housing.

18. The optical semiconductor lighting apparatus according to claim 1, wherein the optical semiconductor devices are radially arranged with respect to a center of the substrate.

19. The optical semiconductor lighting apparatus according to claim 1, wherein a plurality of optical semiconductor devices is radially arranged with respect to a center of the substrate and separated a predetermined distance from the periphery of the substrate and an inner end of the cutaway slot.
